(19) United States
(12) Patent Application Publication
(10) Pub. No.: US 2007/0142942 A1
(43) Pub. Date: Jun. 21, 2007

(54) Audio profiles for portable music playback device

(75) Inventor: Edward Craig Hyatt, Durham, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/303,243

(22) Filed: Dec. 16, 2005

(51) Int. Cl. G06F 17/00; H04R 1/10

(52) U.S. Cl. 700/94; 381/74

(57) ABSTRACT

A portable music player includes an audio circuit for processing input audio signals to generate output audio signals and a set of speakers connected to said audio circuit for converting output audio signals into audible signals. A headset interface provides means for connecting a headset to said audio circuit for playback of audio signals through said headset. Audio profiles for said speakers and said headset are stored in memory. A control circuit selects an audio profile depending on whether a headset is connected with said headset interface, and configures said audio circuit based on the selected profile.

### BACKGROUND

With recent advancements in digital electronics and memory devices, ownership of digital media players has become commonplace. Digital media devices are now commonly available for playing audio, video, or both. Media players with audio playback capabilities typically include a built-in speaker and come with an accessory stereo headset. Many audio players allow users to store settings for volume and audio enhancement functions. Exemplary audio enhancement functions include stereo widening, bass enhancement, and equalization. Stereo widening is an effect for use with closely-spaced speakers that introduces a slight delay between channels to create a “virtual stereo” effect. Bass enhancement is a feature that boosts lower frequencies through special audio processing. Equalization is a technique for boosting or attenuating selected frequencies. The equalization settings can be manually selected by the user. Alternatively, equalization presets can be predefined and stored in memory.

Typically, the audio settings that a user selects for use with a headset will be different from the audio settings selected for use with built-in speakers. For example, bass enhancement and stereo widening may be desirable for built-in speakers to generate better sound quality, but may be unnecessary with a high quality stereo headset. Currently, there is no convenient way to select audio settings when switching between listening modes. Instead, the user must manually change the audio settings when switching between modes.

### SUMMARY OF THE INVENTION

The present invention provides a method for automatically adjusting audio settings when a user changes the listening mode. Audio profiles, which are either selected by the user or pre-set at the factory, are stored in memory for each defined listening mode. The audio profiles contain the desired settings for the corresponding listening modes. A control circuit determines the listening mode and automatically loads the corresponding audio profile for the selected listening mode.

In one exemplary embodiment, an audio profile is stored for a speaker mode and headset mode. The speaker mode serves as a default listening mode. A detection circuit detects when a headset is connected and generates a status signal that is input to the control circuit. The control circuit selects either the speaker mode or headset mode, depending on whether the headset is connected. In another exemplary embodiment, an operating mode, such as a speaker mode or a headset mode, is automatically enabled responsive to connecting or disconnecting an external device, such as a headset, to an audio device, such as a portable music player.

### BRIEF DESCRIPTION OF THE DRAWINGS

FIG. 1 is a functional block diagram illustrating the main elements of an exemplary music phone.

FIG. 2 is a perspective drawing of the exemplary music phone.

FIG. 3 is a block diagram illustrating an exemplary detection circuit for detecting when a headset is connected to the exemplary music phone.

FIG. 4 is a flow diagram illustrating an exemplary configuration procedure for loading audio profiles.

### DETAILED DESCRIPTION

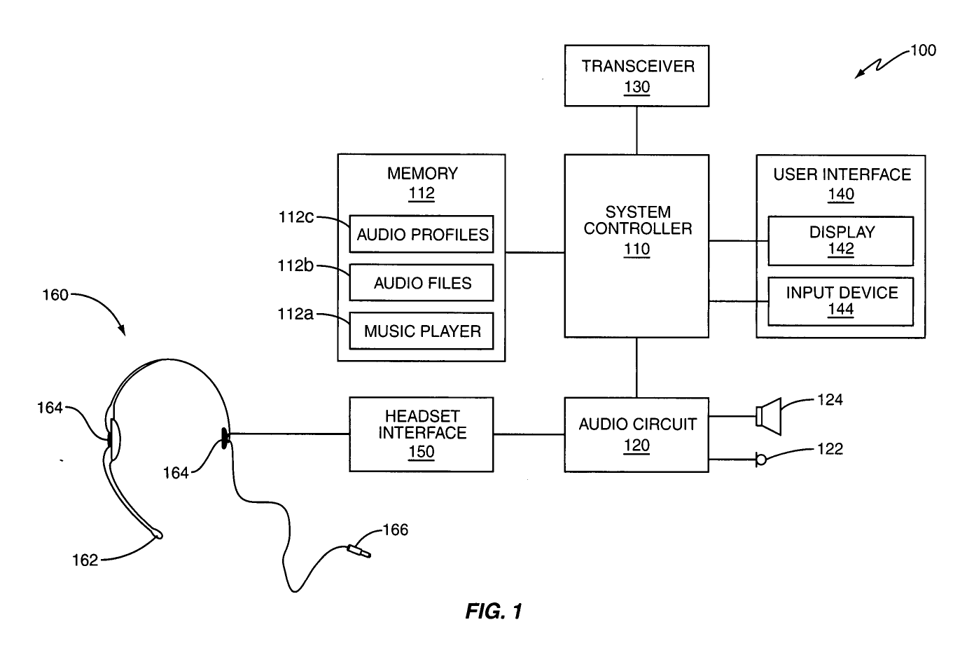

FIG. 1 illustrates a music phone 100 according to one embodiment of the present invention. The music phone 100 combines a mobile communication device and music player 112a in a single device. As used herein, the term mobile communication device means any portable device used for communication and includes without limitation, cellular telephones, cordless telephones, personal digital assistants, palmtop and laptop computers, and other such devices having a radiotelephone. The music phone 100 can be used as both a music player 112a to play recorded music, and as a cellular telephone to place and receive calls.

The main elements of music phone 100 include a system controller 110, memory 112, audio processing circuit 120, transceiver 130, and user interface 140. Cameras and other devices (not shown) may also be incorporated into music phone 100 to provide additional functionality and greater utility.

System controller 110 controls the overall operation of music phone 100 according to program instructions stored in memory 112. The system controller 110 may comprise one or more microprocessors, microcomputers, digital signal processors, special purpose hardware circuits, firmware, software, or a combination thereof. System controller 110 may be contained or implemented in an application specific circuit (ASIC). The functions of the system controller 110 may be embodied in a single processor or ASIC, or may be distributed among several such devices.

Memory 112 comprises one or more memory devices for storing program instructions and data needed for operation. The memory 112 also stores application data and user data, such as recorded music for playback. Memory devices comprising memory 112 may include both volatile (e.g., Random Access Memory (RAM)) and nonvolatile memory devices (e.g., Read Only Memory (ROM)). Further, memory 112 may include removable memory devices, such as CD ROMs, memory sticks and memory cards.

Audio processing circuit 120 processes input and output audio signals. Audio processing may include, for example, compressing/decompressing audio signals, signal conversion (e.g. digital-to-analog and vice versa), filtering, amplifying. Audio processing circuit connects to a microphone 122 and speakers 124. Microphone 122 converts acoustic signals to electrical audio signals for input to audio processing circuit 120. Speaker 124 converts electrical audio signals output by the audio processing circuit 120 into acoustic signals.

Transceiver 130 enables wireless communication with remote devices, and may comprise a fully functional cellular transceiver, such as a GSM (Global System for Mobile communications) or CDMA (Code Division Multiple Access) transceiver. Alternatively, the transceiver 130 may also comply with evolving WiMAX standards. Those skilled in the art will appreciate that the particular technology employed by transceiver 130 is not material and that the teachings of this application can be applied with any known type of transceiver.

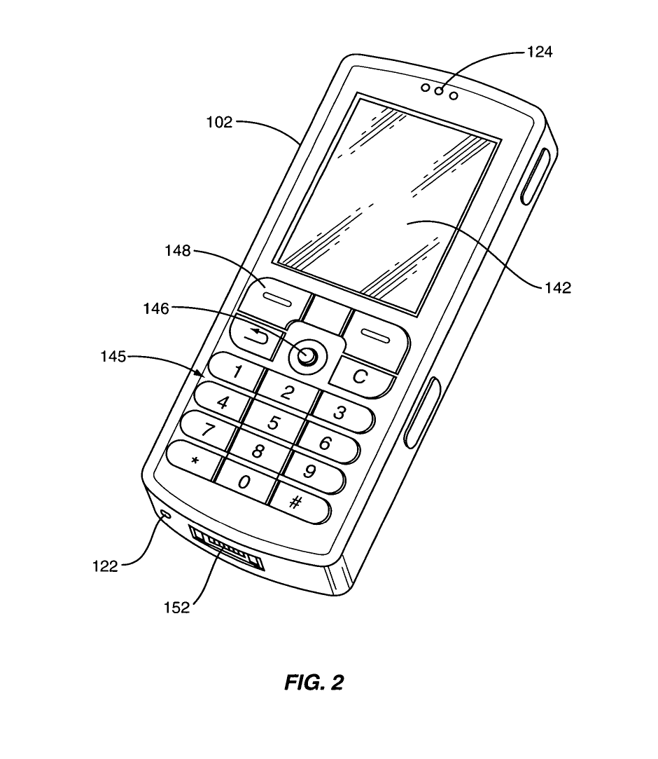

User interface 140 provides a man-to-machine interface between the user and system controller 130. The user interface 140 includes a display 142 for presenting information for viewing by the user, and one or more input devices for receiving user input. Any known input devices may be used, including without limitation keypads, buttons, dials, slides, joysticks, pointing devices, and touch pads. Additionally, the display may be a touch screen display for receiving user input. Voice activation technology may also be employed to receive user input. In the exemplary embodiment described herein, the input devices include a keypad 145, joystick 146, and function keys 148 as shown in FIG. 2.

A headset interface 150 provides an interface between the music phone 100 and an accessory headset 160. The headset interface 150 may comprise a system connector 152, or may comprise a wireless interface, such as a Bluetooth® interface. Headset 160 may include a microphone 162 and headset speakers 164. The headset 160 may be a wired headset with a connector 166 that plugs into the system connector 152 in music phone 100. Alternatively, headset 160 may comprise a wireless headset having a short-range transceiver, such as a Bluetooth® transceiver, for communicating wirelessly with music phone 100.

FIG. 2 illustrates how music phone 100 may appear in one exemplary embodiment. The music phone 100 includes a housing 102. The front side of housing 102 contains the display 142, keypad 145, joystick 146, and multiple function keys 148. Speaker 124 is located above display 142. The microphone 122 and system connector 152 are located on the bottom end of housing 102. System connector 152 is used to connect the music phone 100 to various peripheral devices and accessories. As noted above, system connector 152 may mate with headset connector 166 to connect the headset 160 with the audio processing circuit 120.

Music phone 100 is intended for use as both a mobile telephone and music playback device. Music and other audio files may be stored in memory 112 for playback through either the built-in speaker 124 or headset 160. Additionally, music phone 100 may include the ability to play streaming audio received by transceiver 130. The music phone 100 may include a music application, referred to herein as a music player 112a, for managing and playing music files and/or other audio files 112b. Music player 112a may also include editing capabilities for editing stored audio files 112b. In the exemplary embodiment, the music player 112a allows the user to set preferences controlling music playback, audio effects, etc. The user's settings, referred to herein as audio settings, may be stored as an audio profile 112c. The audio profile 112c may be a single file or set of files defining operating parameters for configuring the audio processing circuit 120. The audio settings are preferably changeable by the user through software in the music player 112a. The audio profile 112c is stored in memory 112 and accessed by the system controller 110 to configure audio processing circuit 120.

Table 1 below represents one exemplary set of audio preferences.

TABLE 1
Audio Preferences

| Preference | Settings/Options | Description |
|---|---|---|
| STEREO WIDENING | On/Off | Used to create |
| | | a virtual stereo |
| | | effect |
| MEGA BASS ™ | On/Off | Used to enhance |
| | | lower frequencies |
| EQUALIZATION | On/Off | Selectively boosts |
| | | and attenuates |
| | | frequencies in |
| | | an audio signal |
| EQUALIZATION | Normal/Vocal/Bass/ | Predefined |
| PRESET | Mega Bass ™/Manual | equalization |
| | | filters |
| INCOMING CALL | Background/Fade/Mute | Defines how audio |
| | | is handled |
| | | responsive to |
| | | an incoming call |

The audio preferences include STEREO WIDENING, MEGA Bass™, EQUALIZATION, EQUALIZATION PRESET, and INCOMING CALL. Stereo widening is an audio enhancement that provides the listener with a virtual stereo effect, even when the built-in speakers 124 are too close together for normal stereo. Mega Bass™ is an audio enhancement that boosts lower frequency sounds in an audio signal. Equalization is a technique of boosting and attenuating selected frequencies in an audio signal to tailor the sound to an individual's preferences. An equalization preset is a predefined equalization filter that can be selected by the user. When manual is selected, the user manually sets the filter for each frequency band. The incoming call function indicates how music is played back in response to an incoming call. The incoming call options may include, for example, a fade option, background option, and mute option. The mute option stops music playback during a call. The fade option gradually decreases volume to a predetermined level at the beginning of a call and gradually increases the volume when the call is complete. The background option reduces the volume of music during a call allowing it to be played in the background.

When music player 112a is started, a configuration routine may be executed to determine or select a listening mode (e.g., speaker mode or headset mode). Additionally, the configuration routine may load the audio settings contained in the stored audio profile 112c for the selected listening mode. To load the audio profile 112c, the configuration routine accesses the audio profile 112c in memory 112, reads the audio settings, and configures the audio processing circuit 120.

Multiple audio profiles 112c may be stored in memory 112 and selected depending on a selected listening mode. For example, a first audio profile 112c may be stored in memory 112 for use when speaker mode is enabled, i.e., audio is played back through the built-in speakers 124. A second audio profile 112c may be stored in memory 112 for use when headset mode is enabled. Table 2 below gives the exemplary settings for a speaker profile for the speaker mode and headset profile for the headset mode.

TABLE 2
Exemplary Audio Profiles

| Preference | Speaker Mode | Headset Mode |
|---|---|---|
| STEREO WIDENING | On | Off |
| MEGABASS ™ | On | Off |
| EQUALIZATION | On | On |
| EQUALIZATION | Bass | Manual |
| PRESET | | |
| INCOMING CALL | Fade | Background |

In the speaker mode, the stereo widening, Mega Bass™, and equalizer functions are enabled. The “bass” preset for the equalizer is selected and the fade option is selected for incoming calls. In the headset mode, stereo widening and Mega Bass™ functions are disabled, and the equalizer function is enabled. The “manual” preset is selected for the equalizer. When the equalizer preset is set to “manual,” the user manually sets the equalizer to boost or attenuate various frequencies. The “Background” option is selected for incoming calls. With this option, music will play in the background during a call.

Those skilled in the art will appreciate that additional listening modes can be provided. For example, if music phone 100 is equipped with a Bluetooth® interface, listening modes and corresponding audio profiles 112c could be defined for outputting audio to a car stereo system or home stereo system when available.

The listening mode can be manually selected by the user, or selected automatically. Music player 112a may be programmed to automatically detect the headset 160 and select a headset mode when the headset 160 is operatively connected to music phone 100.

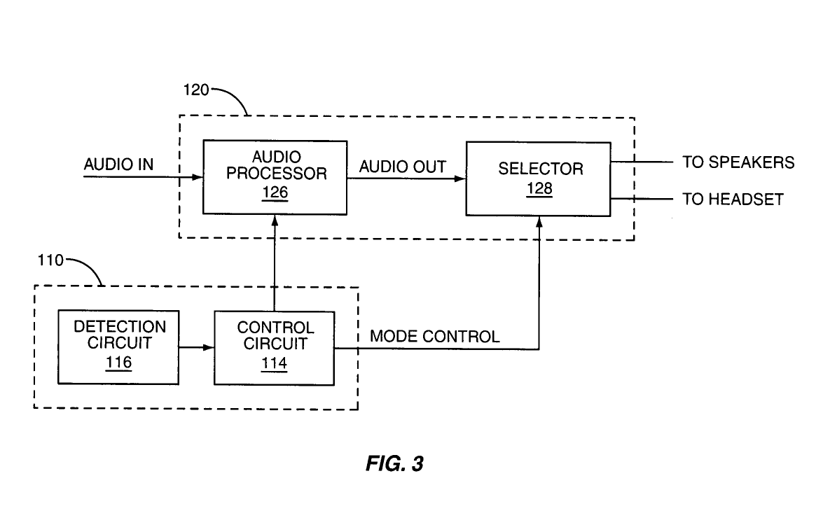

FIG. 3 illustrates further details of the system controller 110 and audio processing circuit 120 according to one exemplary embodiment. The system controller 110 comprises a control circuit 114 and detection circuit 116. Control circuit 114 controls operation of the music phone 110 as previously described. Detection circuit 116 generates a detect signal for input to the control circuit 114. When headset 160 is disconnected, the detect signal has a voltage of V+. When headset 160 is connected, the detect signal is pulled to ground. The control circuit 114 selects a listening mode (e.g., speaker mode or headset mode) depending on the state of the detect signal from the detection circuit 116 and generates a mode control signal. The mode control signal is applied to an input of a selector 128, shown as part of the audio processing circuit 120, that directs audio output to either speakers 124 or headset 160. Additionally, control circuit 114 accesses the audio profile 112c in memory 112 for the selected listening mode, reads the audio settings stored in the audio profile 112c, and configures an audio processor 126 in audio processing circuit 120 based on the selected audio profile 112c. The audio processor 126 processes audio input signals to generate audio output signals. The selector 128, responsive to the mode signal from control circuit 114, directs the audio output signal to either speakers 124 or headset 160. Selector 128 may comprise, for example, a switching circuit.

In the case of a wireless headset, the Bluetooth® transceiver in the headset interface may function as a detection circuit 116 to detect the presence of the headset 160 when the headset 160 is brought into the proximity of the music phone 100. The Bluetooth® transceiver 150 can generate a detect signal for the system controller 110 indicating when headset 160 is connected. Alternatively, the system controller 110 could be programmed to query the Bluetooth® transceiver 150 to determine whether the headset 160 is present.

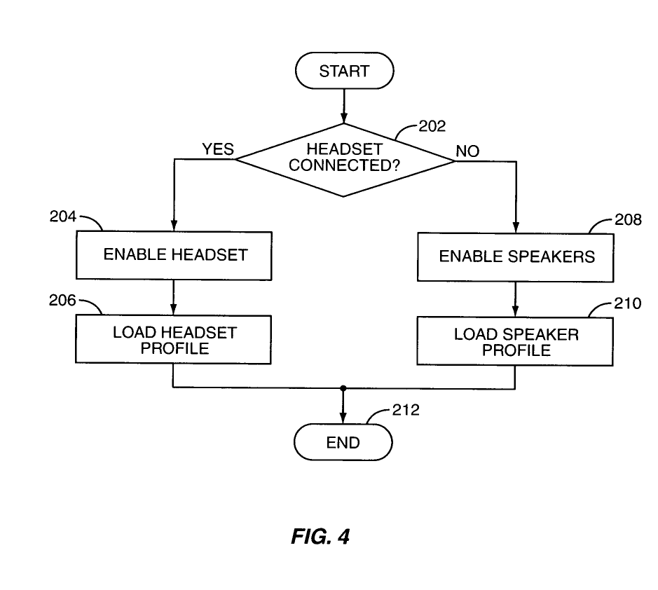

FIG. 4 illustrates a configuration procedure for configuring the music player 112a according to one exemplary embodiment. The configuration routine may be executed when music player 112a is started, or may be executed upon the occurrence of predetermined triggering events. A change in the state of the detect signal from the detection circuit 116 may be one triggering event. When the configuration routine is invoked, either during start-up or after the occurrence of a triggering event, control circuit 114 determines whether headset 160 is connected (block 202). If the headset 160 is detected, control circuit 114 enables the headset 160 (block 204) to output audio through headset 160 and loads the headset profile to configure the music phone 100 (block 206). On the other hand, if no headset 160 is detected, control circuit 114 enables speakers 124 (block 208) to output audio through the speakers 124, and loads the speaker profile to configure the music phone 100 for the speaker mode (block 210). After loading the appropriate profile (blocks 206, 210), the configuration procedure ends (block 212).

The ability to store multiple profiles allows users to optimize the audio settings for different situations without having to manually change the settings. Thus, the present invention should provide greater convenience and enhance the listening experience of the user.

While the above describes configuring an audio circuit based on an audio profile stored in memory, it will be appreciated that the present invention also includes configuring an audio circuit based on a hardwired audio profile. According to this embodiment, detection circuit 116 generates a detect signal for input to the control circuit 114 responsive to a headset 160 being connected to or disconnected from the portable music player. The control circuit 114 configures the audio processor 126 in the audio processing circuit 120 to switch to a particular listening mode (e.g., speaker mode or headset mode) depending on the state of the detect signal from the detection circuit 116 and generates a mode control signal. The selector 128, responsive to the mode control signal from control circuit 114, directs the audio output signal to either speakers 124 or headset 160. For example, plugging in or unplugging headset 160 may automatically switch an equalizer circuit off or on, respectively.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A portable music player comprising:
memory for storing respective audio profiles for two or more listening modes; and
a control circuit to select an audio profile depending on a selected listening mode, and to configure an audio circuit based on the selected profile.

2. The portable music player of claim 1 wherein one of said listening modes comprises a speaker mode wherein audio is output to internal speakers and one of said listening modes is a headset mode wherein audio is output to a headset.

3. The portable music player of claim 2 further comprising a detection circuit connected to the control circuit to detect the connection of said headset, said control circuit responsive to a signal output by said detection circuit to switch between said speaker mode and said headset mode.

4. The portable music player of claim 1 wherein said audio profiles store one or more audio settings for configuring said audio circuit.

5. The portable music player of claim 4 wherein said audio settings include a setting for at least one audio enhancement effect.

6. The portable music player of claim 5 wherein said audio enhancement effect includes at least one of stereo widening, bass enhancement, and audio equalization.

7. The portable music player of claim 4 wherein said audio settings include a call setting controlling audio playback responsive to an incoming call.

8. The portable music player of claim 7 wherein options for said call setting include a fade option for gradually muting and resuming audio playback at the beginning and end of a call, respectively.

9. The portable music player of claim 7 wherein options for said call setting include a background option for reducing volume of said audio playback during said call.

10. A method of configuring an audio circuit for a portable audio device, said method comprising:
storing audio profiles in memory for two or more listening modes;
selecting an audio profile for a selected listening mode; and
configuring said audio circuit based on the selected audio profile.

11. The method of claim 10 further comprising processing input audio signals with said audio circuit to generate output audio signals.

12. The method of claim 10 wherein one of said listening modes comprises a speaker mode wherein audio is output to internal speakers and one of said listening modes is a headset mode wherein audio is output to a headset.

13. The method of claim 12 wherein selecting an audio profile for a selected listening mode comprises selecting a speaker profile when said speaker mode is enabled and selecting said headset profile when said headset mode is enabled.

14. The method of claim 13 further comprising:
determining whether said headset is connected; and
selecting said speaker mode or said headset mode depending on whether said headset is connected.

15. The method of claim 10 wherein said audio profiles store one or more audio settings for configuring said audio circuit.

16. The method of claim 15 wherein said audio settings include a setting for at least one audio enhancement function.

17. The method of claim 16 wherein said audio enhancement function includes one of stereo widening, bass enhancement, and audio equalization.

18. The method of claim 15 wherein said audio settings include a call setting controlling audio playback responsive to an incoming call.

19. The method of claim 18 wherein options for said call setting include a fade option for gradually muting and resuming audio playback at the beginning and end of a call, respectively.

20. The method of claim 18 wherein options for said call setting include a background option for reducing volume of said audio playback during said call.

21. A portable music player comprising:
an audio circuit for processing input audio signals to generate output audio signals;
a speaker connected to said audio circuit for converting output audio signals into audible signals;
a headset interface for connecting a headset to said audio circuit;
memory for storing respective audio profiles for said speaker and said headset; and
a control circuit to select an audio profile depending on whether a headset is connected with said headset interface, and to configure said audio circuit based on the selected audio profile.

22. The portable music player of claim 21 further comprising a detection circuit to detect the connection of said headset with said headset interface and to generate a status signal for input to said control circuit.

23. A portable music player comprising:
a detection circuit configured to detect the connection of a headset to the portable music player; and
a control circuit connected to the detection circuit, wherein said control circuit configures an audio circuit in the portable music player based on an output signal by the detection circuit.

24. The portable music player of claim 23 wherein the control circuit configures the audio circuit to implement an audio enhancement effect.

25. The portable music player of claim 24 wherein the audio enhancement effect includes at least one of a stereo widening, bass enhancement, and audio equalization.

26. A method of configuring an audio circuit for a portable audio device, said method comprising:
detecting the connection of a headset to the portable audio device; and
configuring an audio circuit in the portable audio device depending on whether the headset is connected.

27. The method of claim 26 wherein configuring the audio circuit comprises configuring the audio circuit to implement an audio enhancement effect.

28. The method of claim 27 wherein the audio enhancement effect includes at least one of a stereo widening, bass enhancement, and audio equalization.
